(19) United States
(12) Patent Application Publication
(10) Pub. No.: US 2008/0289961 A1
(43) Pub. Date: Nov. 27, 2008

(54) Sensor Element

(76) Inventors: Reiner Schmitt, Reundorf (DE); Thomas Wahl, Pforzheim (DE); Harald Guenschel, Gerach (DE); Harry Braun, Heimsheim (DE); Andy Tiefenbach, Farmington Hills, MI (US); Ulrich Eisele, Stuttgart (DE); Lothar Diehl, Gerlingen (DE); Thomas Moser, Schwieberdingen (DE); Stefan Rodewald, Ditzingen (DE); Dieter Lindauer, Muehlacker (DE); Juergen Sindel, Vaihingen/Enz (DE); Dirk Rady, Ditzingen (DE); Frank Buchholz, Neckartenzlingen (DE)

Correspondence Address: KENYON & KENYON LLP, ONE BROADWAY, NEW YORK, NY, 10004, US

(21) Appl. No.: 10/593,021

(22) PCT Filed: Feb. 9, 2005
(86) PCT No.: PCT/EP2005/050560

§ 371 Date: Aug. 4, 2008

(30) Foreign Application Priority Data
Mar. 19, 2004 (DE) 10 2004 013 545.2

(51) Int. Cl. G01N 27/26

(52) U.S. Cl. 204/424

(57) ABSTRACT

A sensor element for determining the oxygen concentration in an exhaust gas has a conductor track applied to a solid electrolyte, which includes an electrode provided in a measuring area of the sensor element and an electrode lead connected to the electrode and situated in the lead area of the sensor element. In a transition area between the measuring area and the lead area, the conductor track has a narrowing. Furthermore, the electrode includes a first electrode section and a second electrode section, the first electrode section being connected to the electrode lead in a transition area between the measuring area and the lead area, and the first and second electrode sections being electrically connected to one another only on their sides facing away from the lead area.

### FIELD OF THE INVENTION

The present invention is directed to a sensor element for detecting a gas component.

### BACKGROUND INFORMATION

Published German patent document DE 100 13 882, for example, describes a planar sensor element which is layered using silk-screen technology and contains a measuring gas space in which two annular electrodes are situated on two opposite sides. The two electrodes are parts of an electrochemical cell, which has an additional electrode and a solid electrolyte situated between the electrodes. The two electrodes situated in the measuring gas space are connected to a measuring gas located outside the sensor element via an annular diffusion barrier and a gas inlet opening. One of the two electrochemical cells is operated as a Nernst cell, in which a voltage (Nernst voltage) is formed between the electrode in the measuring gas space and the additional electrode exposed to a reference gas; the Nernst voltage is a measure of the ratio of the oxygen partial pressure at the measuring gas space electrode to that at the electrode exposed to the reference gas. The other one of the two electrochemical cells is used as a pump cell, which, by applying a voltage, is made to pump oxygen into or from the measuring gas space in such a way that an oxygen partial pressure of λ=1 is established in the measuring space.

The electrodes are situated on the measuring-side end of the sensor element, i.e., in the measuring area of the sensor element, and are connected, via leads, to contact surfaces connecting the sensor element to an analyzer circuit situated outside the sensor element. The contact surfaces are applied to the external surfaces of the sensor element on the terminal-side end of the sensor element, i.e., in a contact area. The lead area where the leads to the electrodes are situated is provided between the measuring area and the contacting area. The electrode, the lead, and the contact surface together form a conductor track.

The electrochemical cells in the measuring area of the sensor element are heated by a heating element to a temperature at which the solid electrolyte has a sufficiently high conductivity for oxygen ions.

The disadvantage of a sensor element of this type is that heat is removed from the measuring area of the sensor element via the conductor track, in particular via the electrode lead. As a result of the heat flow from the measuring area, a high-performance heating element must be used to heat the measuring area of the sensor element to the required temperature. In addition, the sensor element is also heated in the lead area and the contacting area, so that the oxygen ion conductivity of the solid electrolyte in the lead and contacting areas increases, which may impair the measuring signal. Furthermore, due to the heat flow from the measuring area, a temperature gradient is established on the electrode surface, whereby the function of the electrode and thus ultimately the measuring function of the sensor element is impaired.

Providing conductor tracks with open porosity to form three-phase boundaries on the electrodes, at which oxygen transfer between gas and solid electrolyte is possible, is also known. If the conductor track has an electrode situated in the measuring gas space and the lead of the conductor track is connected to the reference gas, it is disadvantageous that a reference gas containing a high proportion of oxygen may reach the measuring space via the interconnected pores (open porosity) of the conductor track, since this modifies the oxygen partial pressure in the electrode area and distorts the measuring signal.

### SUMMARY

The sensor element according to the present invention has the advantage over the related art that heat conduction from the measuring area along the conductor track is reduced and the electrode has a largely constant temperature over its surface.

For this purpose, the conductor track has at least one narrowing, which is configured in such a way that heat conduction along the longitudinal direction of the conductor track from the measuring area into the lead area is reduced. The narrowing is provided in a transition area between the measuring area and the lead area. The narrowing may be implemented as a constriction and/or via a recess or multiple recesses.

The conductor track has a smaller cross-section area in the area of the narrowing than in the areas adjacent to the narrowing. Areas adjacent to the narrowing are to be understood as the areas adjacent to the narrowing both in the direction of the measuring area and in the direction of the lead area. In other words, if the cross-section area were to be plotted against the length of the conductor track, the resulting function would have a minimum in the area of the narrowing. Cross-section area is to be understood as the area of the conductor track in a plane perpendicular to the heat gradient formed due to the heating of the measuring area in the conductor track. The heat gradient is usually oriented parallel to the length of the conductor track.

The cross-section area in the area of the narrowing is at most 70 percent, e.g., 50 percent of the cross-section area of the conductor track in an area adjacent to the narrowing. The area through which the heat flow from the measuring area into the lead area may take place is thus reduced.

In an example embodiment of the present invention, the narrowing is designed via at least one slot-shaped recess, which has a longer side and a shorter side, the longer side being approximately perpendicular to the length of the conductor track.

In an alternative example embodiment of the present invention, a plurality of recesses is provided in the area of the narrowing of the conductor track, whereby a netlike structure is formed in the conductor track. The recesses are advantageously offset to one another with respect to the longitudinal axis of the conductor track.

In another, alternative example embodiment, the narrowing is designed as a constriction of the conductor track, so that the width of the conductor track in the area of the constriction is smaller than the width of the conductor track in the areas adjacent to the constriction. In an example manner, the width of the conductor track in the area of the constriction is at most 70 percent, e.g., 50 percent of the width of the conductor track in the areas adjacent to the constriction.

Heat conduction from the measuring area into the lead area is effectively reduced by the above-mentioned example embodiments.

In a particularly advantageous manner, the conductor track is additionally used for shielding electrodes terminated with a high resistance, such as a reference electrode. For this purpose, the conductor track is situated in such a way that it absorbs fault currents and/or shields against electrical interference that may come from the heater. A wide conductor track is required for effective shielding. However, making a conductor track wider also increases its cross-section area. Large cross-section areas result in an undesirably high heat conduction. Therefore, according to the present invention, recesses are provided to implement a wide conductor track having a relatively small cross-section area. Width b of the conductor track is to be understood as the dimension of the conductor track perpendicularly to its length and parallel to the major surface of the sensor element. Width b identifies the distance between the boundaries of the conductor track in that direction and is therefore the same for a conductor track of a given external contour regardless of whether or not it has recesses. In contrast, cross-section area A is reduced by the introduction of recesses. Since the recesses have only a slight effect on the quality of the shielding, the shielding of the conductor track having recesses (for the same width b) is comparable to that of a conductor track without recesses. However, since cross-section area A is considerably reduced by the introduction of the recesses, the heat conduction of a conductor track having recesses is considerably lower than that of a conductor track without recesses. The ratio A/b≦0.1 mm, e.g., A/b≦0.02 mm, is advantageously met in the recess area, which helps achieve good shielding with low heat conduction.

The ratio b/c≦0.8, e.g., b/c≦0.5, is also advantageously met, b again being the (total) width of the conductor track, with c being the sum of widths of the individual sections of the conductor track, which are interrupted by the recess(es). The height of the conductor track, i.e., the dimension of the conductor track in the direction perpendicular to the major surface of the sensor element, is advantageously in the range of 4 μm to 20 μm, e.g., in the range of 5 μm to 10 μm.

It is also advantageous that a gas diffusion diminishes along the conductor track according to the present invention having a narrowing. Reference gas may penetrate into the measuring gas space through a conductor track having an open porosity, which results in distortion of the measuring signal. The cross section of the conductor track is reduced and thus the gas flow through the conductor track is limited by the narrowing. In a particularly advantageous manner, the conductor track includes an area in which the gas diffusion per unit of surface area is considerably further limited or even totally suppressed, for example, by a structure having closed pores or no pores being provided in this area. Using this measure, a gas having high oxygen content may be effectively prevented from reaching the measuring gas space from the terminal-side end section of the sensor element via the conductor track. Normally the conductor track contains a metallic portion, for example, platinum, and a ceramic portion, for example, yttrium oxide-stabilized zirconium oxide. By reducing the ceramic portion, the proportion of pores is reduced or an area having a closed porosity is provided. The conductor track area in which the gas diffusion is substantially limited or totally suppressed is advantageously provided directly next to the measuring gas space and is short compared to the total length of the conductor track.

In an alternative example embodiment of the present invention, which may be implemented independently from the above-mentioned measures, the electrode situated entirely in the measuring space has a first and a second electrode section, the first electrode section being electrically contacted by the electrode lead in the transition area between the measuring area and the lead area, and the second electrode section and the first electrode section being electrically connected only on their sides facing away from the lead area. In such a system, the heat may flow from the second electrode section to the lead of the conductor track only via the first electrode section. This reduces the heat flow, in particular from the second electrode section into the lead, without impairing the measuring function of the electrode (for example, by reducing the surface area of the electrode).

### BRIEF DESCRIPTION OF THE DRAWINGS

FIG. 1 shows a sensor element according to the present invention in longitudinal cross-section.

FIG. 2 shows the heating power and the temperature distribution along an axis parallel to the longitudinal axis of the sensor element.

FIG. 3 shows the sensor element according to the present invention in cross section taken along line III-III in FIG. 1.

FIG. 4 shows an embodiment of a conductor track of the sensor element according to the present invention in top view.

FIG. 5 shows the conductor track in a cross-section taken along line V-V in FIG. 4.

FIGS. 6 through 11 show further example embodiments of a conductor track of the sensor element according to the present invention in top view.

### DETAILED DESCRIPTION

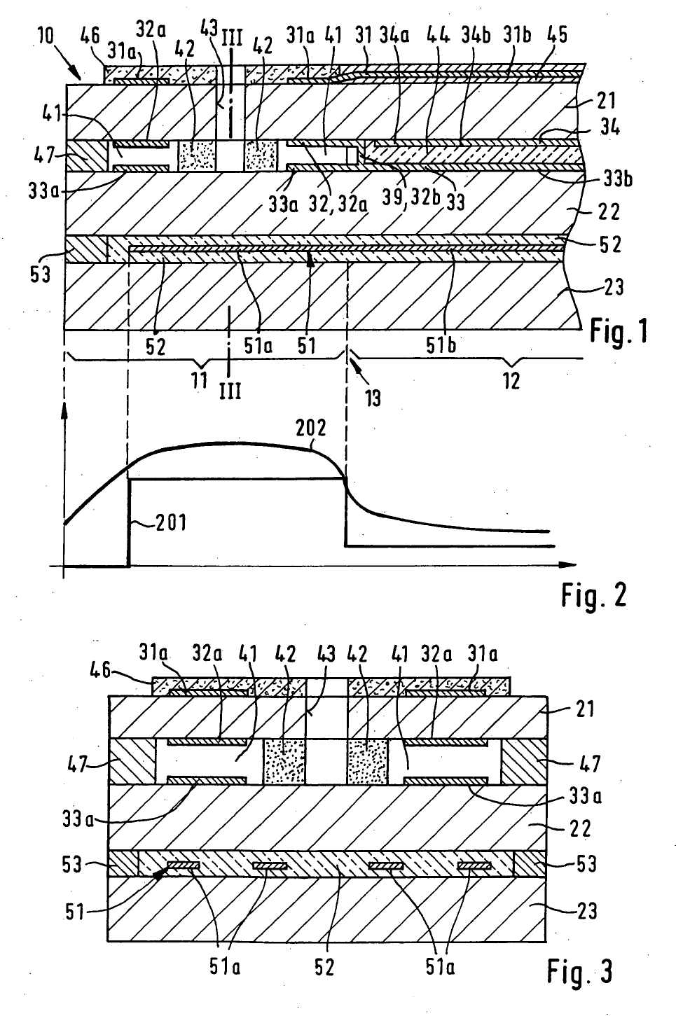

FIGS. 1 and 3 show, as example embodiments of the present invention, a sensor element 10 having a first solid electrolyte layer 21, a second solid electrolyte layer 22, and a third solid electrolyte layer 23. A hollow cylindrical measuring gas space 41, having a hollow cylindrical diffusion barrier 42 in its center, is provided between first and second solid electrolyte layers 21, 22. First solid electrolyte layer 21 has a gas inlet opening 43, through which the measuring gas located outside sensor element 10 may reach measuring gas space 41 via diffusion barrier 42. Measuring gas space 41 is surrounded by a sealing frame 47, which laterally seals measuring gas space 41 in a gas-tight manner.

Sensor element 10 has a heated measuring area 11 and a lead area 12. The area between measuring area 11 and lead area 12 is referred to as transition area 13. The heating of measuring area 11 by a heating element 51 is described in more detail below (see FIG. 2).

On one side of first solid electrolyte layer 21 forming an external surface of sensor element 10, there is a first conductor track 31, which includes a first electrode 31a and a first lead 31b to first electrode 31a. First conductor track 31 is covered by a porous protective layer 46. Furthermore, an electrically insulating insulation layer 45 is provided between first lead 31b and first solid electrolyte layer 21.

A second conductor track 32, which includes a second lead 32b and a second electrode 32a situated in measuring gas space 41, is applied between first and second solid electrolyte layers 21, 22. Second electrode 32a is applied to first solid electrolyte layer 21 opposite first electrode 31a. A third conductor track 33, which includes a third electrode 33a and a third lead 33b, is situated on the side of second solid electrolyte layer 22 facing first solid electrolyte layer 21. Third electrode 33a is situated in measuring space 41 opposite second electrode 32a. Second electrode 32a is electrically connected to third lead 33b via a lead-through 39. Lead-through 39 may also be provided laterally next to the sectional plane depicted in FIG. 1, so that a fourth electrode 34a, which is described in more detail later, may be situated nearer to measuring gas space 41 and to second and third electrodes 32a, 33a. First, second, and third electrodes 31a, 32a, 33a have an annular design. Diffusion barrier 42 and gas inlet opening 43 are situated in the center of annular electrodes 31a, 32a, 33a.

Next to second electrode 32a, a fourth conductor track 34 having fourth electrode 34a and a fourth lead 34b is situated on first solid electrolyte layer 21. Fourth electrode 34a is exposed to a reference gas. The reference gas may be present in porous fourth conductor track 34 and/or in a porous insulation layer 44, which is provided in lead area 12 between third conductor track 33 and fourth conductor track 34.

Each of electrodes 31a, 32a, 33a, 34a is connected to contact surfaces (not shown) provided on the side of sensor element 10 facing away from measuring area 11 via leads 31b, 33b, 34b. Each of the contact surfaces is connected to contacting elements, which conduct the measuring signals to an external electronic system (also not shown). Since lead 32b of second electrode 32a is electrically connected to third lead 33b via lead-through 39, second and third electrodes 32a, 33a have a shared lead 33b in some areas.

A heating element 51, which includes a heater 51a and a heater lead 51b, is situated between second solid electrolyte layer 22 and a third solid electrolyte layer 23. Heating element 51 is embedded into a heater insulation 52, which electrically insulates heating element 51 from the surrounding solid electrolyte layers 22, 23. Heating element 51 and heater insulation 52 are laterally surrounded by a heater sealing frame 53.

In FIG. 2, curve 201 schematically shows heating power output in the layer plane of heating element 51, and curve 202 shows the temperature variation established in the layer plane between first and second solid electrolyte layers 21, 22 due to the heating of sensor element 10. In FIG. 2, the position along the length of sensor element 10 according to FIG. 1 is plotted on the abscissa, the zero point of the abscissa being located at the measuring gas side end of sensor element 10. Heater 51a outputs an almost constant heating power over its entire surface area, while heating element 51 outputs almost no heat in the area of its heater lead 51b. Second and third electrodes 32a, 33a (like first electrode 31a), as well as diffusion barrier 42 and solid electrolyte layers 21, 22, are heated by heater 51a to an almost constant temperature in measuring area 11. In transition area 13 between measuring area 11 and lead area 12, the temperature of sensor element 10 drops considerably. Transition area 13 is thus formed by the area in which a high temperature gradient is formed when sensor element 10 is heated.

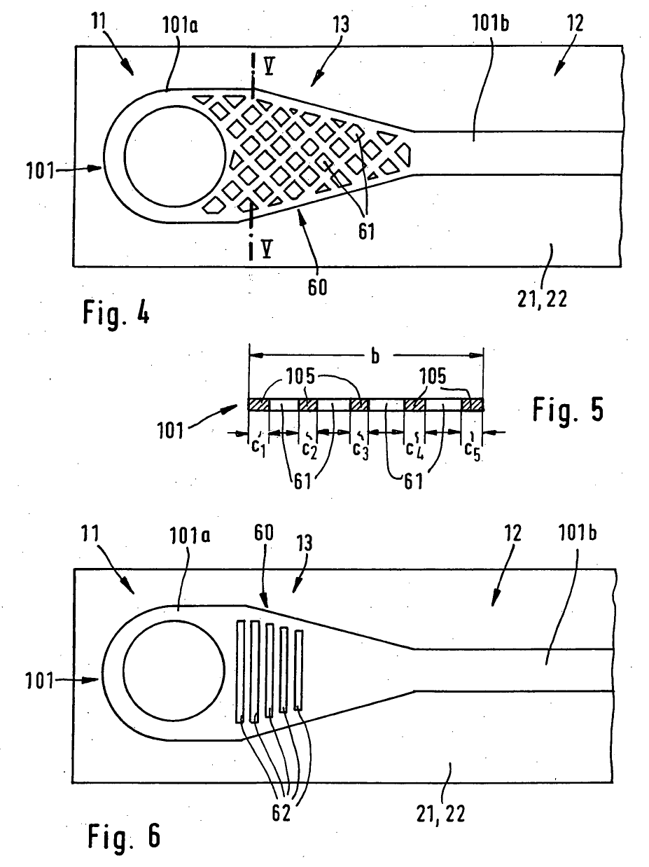

FIG. 4 shows, as an example embodiment of the present invention, a conductor track 101, which includes an electrode 101a and a lead 101b, electrode 101a being situated in measuring area 11 and lead 101b being situated in lead area 12 of sensor element 10. Lead 101b widens on its side facing electrode 101a, i.e., in transition area 13, and has a narrowing 60 with recesses 61 forming a netlike structure in this area 13. Recesses 61 are offset to one another in relation to the longitudinal axis of conductor track 101 and thus also in relation to the longitudinal axis of sensor element 10. Recesses 61 reduce the heat flow from electrode 101a, which is heated by heater 51a, into lead 101b, i.e., from measuring area 11 into lead area 12 of sensor element 10. Recesses 61 divide conductor track 101 into separate conductor track sections 105 in the plane represented by line V-V shown in FIG. 4. Two neighboring recesses 61 are spaced at approximately 200 μm; in general, a spacing between two recesses 61 in the range of 100 μm to 400 μm has been found to be adequate. FIG. 5 shows a section through conductor track 101 in the area of narrowing 60 along line V-V in FIG. 4. Total width b of conductor track 101 along this section line is approximately 3.0 mm. Conductor track 101 has five conductor track sections 105, each having a width of c₁ through c₅, along this section line. Sum c of the widths of the individual partial sections (i.e., c=c₁+c₂+c₃+c₄+c₅) is 1.5 mm to 2.0 mm and thus approximately 50 to 66 percent of total width b. For a layer thickness h of 10 μm, for example, the partial sections in the section plane shown in FIG. 5 have a total cross section A of 0.015 mm² to 0.02 mm², where A=h (c₁+c₂+c₃+c₄+c₅).

FIG. 6 shows a second example embodiment of the present invention, in which narrowing 60 of conductor track 101 is implemented by slot-shaped recesses 62. Slot-shaped recesses 62 extend in the layer plane of conductor track 101 perpendicularly to the longitudinal axis of sensor element 10. The width of recesses 62 is 60 to 80 percent of the total width of conductor track 101.

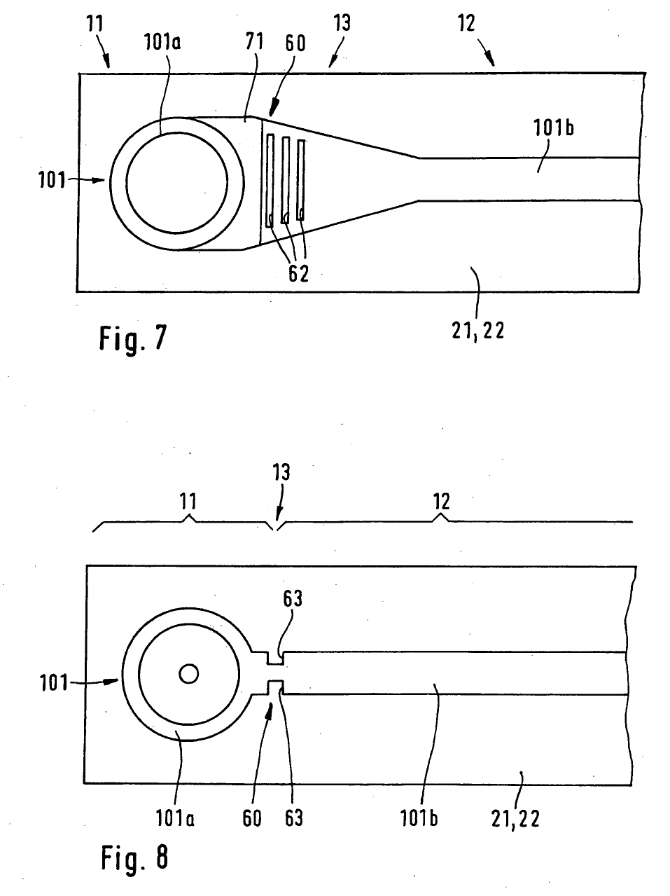

FIG. 7 shows a third example embodiment of the present invention, in which slot-shaped recesses 62 are provided in conductor track 101 as narrowing 60 similar to the second embodiment according to FIG. 6. The third embodiment differs from the second embodiment by a diffusion-inhibiting section 71, which directly adjoins electrode 101a and is provided between electrode 101a and lead 101b containing recesses 62. Diffusion-inhibiting section 71 has a proportion of pores of 4 to 5 percent by volume and a closed porosity; electrode 101a and lead 101b have a proportion of pores of 20 to 30 percent by volume and an open porosity. The proportion of ceramic in diffusion-inhibiting section 71 is approximately 20 percent by volume; the proportion of ceramic in electrode 101a and lead 101b is approximately 30 percent by volume.

FIG. 8 shows a fourth example embodiment of the present invention, in which conductor track 101 has a narrowing 60 designed as a constriction 63. In contrast with the exemplary embodiments of FIGS. 4 through 7, the constriction is implemented not via one or more recesses 61, 62 provided within conductor track 101, but by a reduction of the total width of conductor track 101. The width of conductor track 101 in the area of constriction 63 is approximately 40 percent of the width of conductor track 101 in the areas adjacent to constriction 63.

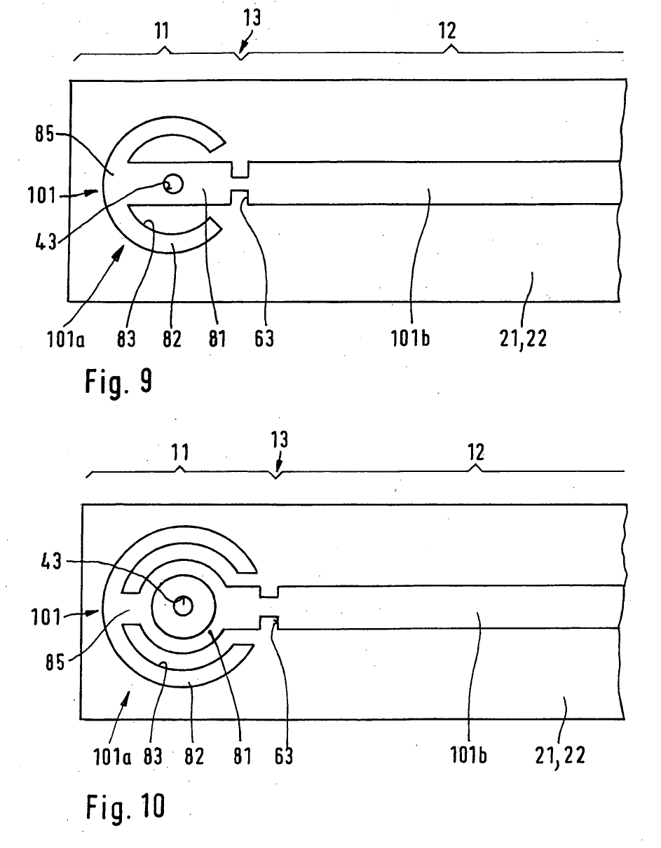

FIGS. 9 and 10 show a fifth and a sixth embodiment of the present invention, respectively, which, like the fourth embodiment according to FIG. 8, has a constriction 63. The fifth and sixth embodiments of the present invention differ from the embodiments according to FIGS. 4 through 8 by the design of electrode 101a, which has a first section 81 and a second section 82. First section 81 of electrode 101a is electrically connected to lead 101b in transition area 13. First section 81 extends from lead 101b over the area of gas inlet opening 43 in the direction of the measuring-side end of the sensor element. Second section 82 of electrode 101a has an annular design and its side facing away from lead area 12 is electrically connected to first section 81 in the area labeled with the numeral 85 in FIGS. 9 and 10. The side of second section 82 facing lead area 12 has a recess 83, in which first section 81 is situated. The sides of first section 81 and second section 82 facing lead area 12 are spaced and not electrically connected.

The fifth and sixth embodiments of the present invention according to FIGS. 9 and 10 differ in the design of first section 81, which is a straight conductor track in FIG. 9 having a recess for gas inlet opening 43, the diameter of this recess being equal to the diameter of the gas inlet opening. In the sixth embodiment according to FIG. 10, first section 81 has an annular recess surrounding gas inlet opening 43, the inner diameter of the annular recess being greater than the diameter of the gas inlet opening.

In the embodiments according to FIGS. 4 through 7, conductor track 101 has a relatively wide cross section in transition area 13, which is interrupted by recesses 61, 62. Conductor track 101, which is wide in transition area 13, functions as a shield against electric interference. Electric interference is shielded effectively in particular if the largest dimension of recesses 61, 62 is smaller than the shortest distance of conductor track 101 provided with recesses 61, 62 to the electrically interfering conductor track (such as heater 51a, for example).

The embodiments according to FIGS. 4 through 7 are particularly well suited for third conductor track 33 in sensor element 10 depicted in FIGS. 1 and 3. In contrast, the embodiments according to FIGS. 8 through 10 are particularly well suited for first conductor track 31 of sensor element 10 depicted in FIGS. 1 and 3. The embodiments of conductor track 101 depicted in FIGS. 4 through 10, however, may be used for any desired conductor tracks in planar exhaust gas sensors independently of the above-described specific advantages due to their reduced heat conduction and gas diffusion.

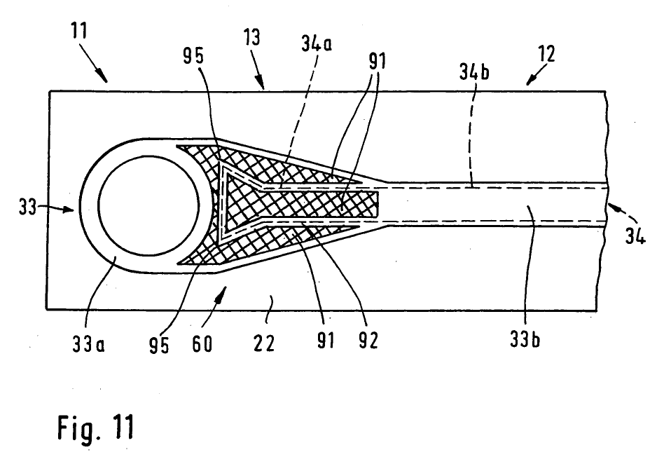

FIG. 11 shows, as the seventh example embodiment of the present invention, a top view of second solid electrolyte layer 22 of sensor element 10 according to FIGS. 1 and 3 and third conductor track 33 together with third electrode 33a and third lead 33b. Furthermore, the projection onto the plane of the drawing of fourth conductor track 34 together with fourth electrode 34a and fourth lead 34b are shown as shaded areas. Transition area 13 of third conductor track 33 has a narrowing 60 having a grid-type structure 91, which, similar to FIG. 4, is implemented using thinner conductor track sections. Grid-type structure 91 is interrupted by a strip 92 designed as a full surface, which extends along the projection of the contour of fourth conductor track 34 onto the layer plane of third conductor track 33. Strip 92 has a width of at least 0.5 mm. In addition, strip 92 may form, in the area of corners 95 of fourth electrode 34a, a circular full surface (not shown), which is greater than that of strip 92, the projection of a corner 95 of fourth electrode 34a onto the layer plane of third conductor track 33 forming the center of the circular full surface. Full-surface strip 92 prevents spark-overs between fourth conductor track 34 and third conductor track 33 through insulation layer 44. Such spark-overs may occur in the case of high field intensities which form, for example, at the edges of fourth electrode 34a, e.g., at its corners 95. Due to strip 92, the edges of fourth electrode 34a are situated opposite a full surface on which relatively low field intensities are formed. This measure reduces the probability of spark-overs through insulation layer 44.

1-27. (canceled)

28. A sensor element for detecting a gas component in a measuring gas, comprising:
a solid electrolyte;
a conductor track applied to the solid electrolyte, wherein the conductor track includes an electrode situated in a measuring area of the sensor element and an electrode lead connected to the electrode and situated in a lead area of the sensor element, and wherein the conductor track has a narrowing in a transition area between the measuring area and the lead area; and
a heater element for heating the measuring area of the sensor element.

29. The sensor element as recited in claim 28, wherein the conductor track has a smaller cross-sectional area in the area of the narrowing than in a first area of the conductor track adjacent to the narrowing.

30. The sensor element as recited in claim 29, wherein the narrowing reduces a heat conduction along the conductor track from the measuring area to the lead area.

31. The sensor element as recited in claim 29, wherein the cross-sectional area of the conductor track in the area of the narrowing is at most 70 percent of the cross-sectional area of the first area of the conductor track adjacent to the narrowing, and wherein each cross-sectional area is defined in a plane perpendicular to a heat gradient occurring when the measuring area of the conductor track is heated.

32. The sensor element as recited in claim 29, wherein in the area of the narrowing, the ratio A/b≦0.1 mm, A being the cross-sectional area of the conductor track in a first plane perpendicular to the longitudinal axis of the sensor element, and b being the width of the conductor track in the first plane.

33. The sensor element as recited in claim 29, wherein the narrowing of the conductor track includes at least one recess.

34. The sensor element as recited in claim 33, wherein the recess is slot-shaped and has a longer side and a shorter side, the longer side of the recess being at least one of: a) approximately perpendicular to a longitudinal extension of the conductor track; and b) approximately perpendicular to a heat gradient formed in the conductor track by the heating of the measuring area.

35. The sensor element as recited in claim 33, wherein the narrowing of the conductor track has a plurality of recesses, and the conductor track has a net-like structure in the area of the recesses.

36. The sensor element as recited in claim 35, wherein the recesses are offset relative to one another along the longitudinal axis of the conductor track.

37. The sensor element as recited in claim 35, wherein in the area of the narrowing, the ratio b/c≦0.8, b being the width of the conductor track in a direction perpendicular to a longitudinal extension of the conductor track, and c being the sum of the widths of individual conductor track sections separated by the recesses.

38. The sensor element as recited in claim 29, wherein the narrowing is configured as a constriction, the width of the conductor track in the area of the constriction being smaller than the widths of areas adjacent to the constriction.

39. The sensor element as recited in claim 38, wherein the width of the conductor track in the area of the constriction is at most 70 percent of the widths of the areas adjacent to the constriction.

40. The sensor element as recited in claim 29, wherein the solid electrolyte includes a first solid electrolyte sheet and a second solid electrolyte sheet, and wherein the conductor track is situated in a layer plane between the first solid electrolyte sheet and the second solid electrolyte sheet.

41. The sensor element as recited in claim 29, wherein the height of the conductor track in a direction perpendicular to a major surface of the sensor element is in the range of 4 μm to 20 μm.

42. The sensor element as recited in claim 29, further comprising:
a first electrochemical cell including a first electrode, a second electrode, and a solid electrolyte sheet situated between the first electrode and the second electrode, wherein the first electrode is applied to an external surface of the sensor element, and the second electrode is provided in a measuring gas space situated within the sensor element and connected to the measuring gas located outside the sensor element via a gas inlet opening and a diffusion barrier; and
a second electrochemical cell including: a) at least one of the second electrode and a third electrode; and b) a fourth electrode, wherein the at least one of the second electrode and the third electrode is electrically connected via a solid electrolyte, and wherein the third electrode is situated within the measuring gas space and the fourth electrode is exposed to a reference gas, and wherein the narrowing of the conductor track encompasses: a) the at least one of the second electrode and the third electrode; and b) the third lead.

43. The sensor element as recited in claim 42, wherein the narrowing of the conductor track is situated between the fourth electrode and the heater element, and wherein the fourth electrode is at least one of electrically insulated and electrically shielded from the heater element by the area of the conductor track that includes the narrowing.

44. The sensor element as recited in claim 43, wherein the narrowing is configured as at least one recess.

45. The sensor element as recited in claim 42, wherein the conductor track includes a strip in the area of the narrowing, and wherein the strip extends along a projection of the contour of the fourth electrode onto the layer plane of the third electrode.

46. The sensor element as recited in claim 45, wherein the width of the strip is at least 0.5 mm.

47. The sensor element as recited in claim 29, wherein the conductor track includes a gas diffusion-inhibiting section which substantially prevents a gas exchange between the electrode of the conductor track and the lead of the conductor track.

48. The sensor element as recited in claim 47, wherein a proportion of pores in the diffusion-inhibiting section of the conductor track is smaller than a proportion of pores in the electrode of the conductor track.

49. The sensor element as recited in claim 48, wherein the proportion of pores in the diffusion-inhibiting section is in the range of 1 to 10 percent by volume, and wherein the proportion of pores in the electrode of the conductor track is in the range of 10 to 50 percent by volume.

50. The sensor element as recited in claim 47, wherein the conductor track includes a metallic portion and a ceramic portion, and wherein the ceramic portion of the diffusion-inhibiting section of the conductor track is smaller than the ceramic portion of the electrode of the conductor track, and wherein the ceramic portion of the diffusion-inhibiting section is in the range of 10 to 40 percent by volume, and the ceramic portion of the electrode of the conductor track is in the range of 15 to 50 percent by volume.

51. The sensor element as recited in claim 47, wherein the electrode of the conductor track has an open porosity, and wherein the diffusion-inhibiting section has a closed porosity.

52. The sensor element as recited in claim 42, wherein the electrode of the conductor track includes a first electrode section and a second electrode section, the first electrode section being connected to the electrode lead in a transition area between the measuring area and the lead area, and wherein the first and second electrode sections are electrically connected to one another only on their sides facing away from the lead area.

53. The sensor element as recited in claim 52, wherein the second electrode section has an annular shape, and a side of the second electrode section facing the lead area has a recess in which the first electrode section is situated.

54. The sensor element as recited in claim 52, wherein the electrode of the conductor track is the first electrode of the first electrochemical cell.
